(19) United States
(12) Patent Application Publication
(10) Pub. No.: US 2018/0247364 A1
(43) Pub. Date: Aug. 30, 2018

(54) GROUPING SYSTEM AND RECOMMENDED-PRODUCT DETERMINATION SYSTEM

(71) Applicant: NEC Corporation, Tokyo (JP)

(72) Inventors: Shinji NAKADAI, Tokyo (JP); Koutarou OCHIAI, Tokyo (JP); Takayuki TERAKAWA, Tokyo (JP)

(73) Assignee: NEC Corporation, Tokyo (JP)

(21) Appl. No.: 15/552,933

(22) PCT Filed: Feb. 2, 2016
(86) PCT No.: PCT/JP2016/000529

§ 371 Date: Aug. 23, 2017

(30) Foreign Application Priority Data
Feb. 25, 2015 (JP) 2015-035238

(51) Int. Cl. G06Q 30/06; G06F 17/30; G06Q 30/02

(52) U.S. Cl. CPC G06Q 30/0631; G06F 17/30598; G06Q 30/0204; G06F 17/30867; G06F 17/30876

(57) ABSTRACT

Provided is a grouping system capable of determining a group of products so that groups of the products likely to be simultaneously purchased can be grasped. A storage means 71 stores at least a purchasing context that is information indicating one or more types of products purchased in one purchasing activity. A grouping means 72 uses a likelihood of a combination of a group of the purchasing contexts, a group of the products, and a distribution parameter of a purchasing result, calculated by using the purchasing result corresponding to the combination of the group of the purchasing contexts, the group of the products, and the distribution parameter of the purchasing result, to determine the group of the purchasing contexts, the group of the products, and the distribution parameter of the purchasing result.

### TECHNICAL FIELD

The present invention relates to a grouping system, a grouping method, and a grouping program that group a purchasing context and a product together, and relates to a recommended-product determination system, a recommended-product determination method, and a recommended-product determination program that determine a recommended product.

### BACKGROUND ART

Basket analysis is known as a general analytical technique for finding products to be bought together. As one of such general analytical techniques, a technique is known for analyzing bundle selling of products on the basis of association rule mining. For example, it is assumed that multiple types of products are purchased in one purchasing activity. Then, it is assumed that purchasing data for multiple purchasing activities exist. In such a case, the above general technique outputs a rule such as “a person who purchases a first product and a second product also purchases a third product”. Then, the above general technique is used for application such as recommendation of products to customers on the basis of the rule.

In addition, examples of general technologies for preference analysis in product purchasing include collaborative filtering based on matrix decomposition. This technology is a technique for decomposing a matrix having customers as rows and products as columns into a matrix with a lower rank. The row after decomposition corresponds to a group of customers, and the column after decomposition corresponds to a group of products. Collaborative filtering analyzes data on multiple purchasing activities of multiple customers.

In addition, in PTL 1, a device is described that calculates a combination of an item (for example, product information), a situation where a user is currently placed, and a desire, and clusters users.

### CITATION LIST

### Patent Literature

PTL 1: Japanese Patent Application Laid-Open No. 2012-256183

### SUMMARY OF INVENTION

### Technical Problem

It is preferable to be able to analyze what kinds of products are sold together in the same purchasing activity.

However, in collaborative filtering, such analysis cannot be made.

In addition, the inventor of the present invention has found the following problem concerning an analytical technique based on association rule mining (Hereinafter, referred to as an analytical technique 1).

When the analytical technique 1 is applied to an individual product, when there are multiple products having similar values (features) for a customer, obtaining an appropriate rule is difficult. For example, it is assumed that, as rice balls having similar values for the customer, a rice ball A and a rice ball B exist, and similarly, as green teas having similar values for the customer, a green tea a and a green tea b exist. In this case, there are four combinations of the rice ball and the green tea having similar values for the customer, and the four combinations having similar values for the customer are treated as different sets, respectively. In addition, when the individual product is analyzed, frequency at which particular products are sold together is small. In the above example, when each set of the four combinations is separately focused, bundle selling frequency of each set is small. As a result, it is difficult to find an appropriate rule on bundle selling.

In addition, it is also considered that an analyst determines product groups, and find product groups sold together with the analytical technique 1. However, in this case, product groups determined by a person are not necessarily appropriate, and an appropriate bundle selling tendency is difficult to be grasped. For example, it is assumed that a rib with a lot of fat and a fillet with less fat are included in a product group “meats”. In addition, it is assumed that a beverage having a fat absorption prevention function and a beverage not having the function are included in a product group “beverages”. Then, it is assumed that the customer has a strong tendency to simultaneously purchase the rib and the beverage having the fat absorption prevention function. In this case, even when an analysis result that the “meats” and the “beverages” are sold together is obtained, since the “meats” includes the fillet with less fat and the “beverages” includes the beverage not having the fat absorption prevention function, a bundle selling tendency of the products cannot be grasped accurately from the analysis result that the “meats” and the “beverages” are sold together.

Therefore, an object of the present invention is to provide a grouping system, a grouping method, and a grouping program capable of solving a technical problem of determining a group of products so that groups of the products likely to be simultaneously purchased can be grasped.

In addition, an object is to provide a recommended-product determination system, a recommended-product determination method, and a recommended-product determination program capable of solving a technical problem of using a result of a group determined so that groups of the products likely to be simultaneously purchased can be grasped, to determine a product to be recommended to a customer.

### Solution to Problem

A grouping system of the present invention includes: a storage means that stores at least a purchasing context that is information indicating one or more types of products purchased in one purchasing activity; and a grouping means that uses a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

In addition, a recommended-product determination system according to the present invention includes: an information storage means that stores information indicating when a customer belonging to a customer group has simultaneously purchased products at a store, which store group the store belongs to, and which product group the products belong to, and a recommended-product determination means that, when a customer, time and a place where the customer is are designated, uses the information, to determine a most suitable product group including a recommended product for the customer, and determine a product in the product group as the recommended product.

In addition, a grouping method according to the present invention is a grouping method to be applied to a grouping system including a storage means that stores at least a purchasing context that is information indicating one or more types of products purchased in one purchasing activity, and the grouping method includes using a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

In addition, a recommended-product determination method according to the present invention includes: deriving information indicating when a customer belonging to a customer group has simultaneously purchased products at a store, which store group the store belongs to, and which product group the products belong to; and, when a customer, time, and a place where the customer is are designated, using the information, to determine a most suitable product group including a recommended product for the customer, and determine a product in the product group as the recommended product.

In addition, a grouping program according to the present invention is a grouping program to be mounted on a computer including a storage means that stores at least a purchasing context that is information indicating one or more types of products purchased in one purchasing activity, and the grouping program causes the computer to execute grouping processing that uses a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

In addition, a recommended-product determination program according to the present invention is a recommended-product determination program to be mounted on a computer including an information storage means that stores information indicating when a customer belonging to a customer group has simultaneously purchased products at a store, which store group the store belongs to, and which product group the products belong to, and the recommended-product determination program causes the computer to execute recommended-product determination processing that, when a customer, time, and a place where the customer is are designated, uses the information, to determine a most suitable product group including a recommended product for the customer, and determine a product in the product group as the recommended product.

### Advantageous Effects of Invention

According to a technical means of the present invention, a technical effect is obtained of making it possible to determine a group of products so that groups of the products likely to be simultaneously purchased can be grasped.

In addition, according to the technical means of the present invention, a technical effect is obtained of making it possible to use a result of a group determined so that groups of the products likely to be simultaneously purchased can be grasped, to determine a product to be recommended to a customer.

### BRIEF DESCRIPTION OF DRAWINGS

FIG. 1 It depicts a block diagram illustrating a configuration example of a grouping system in a first exemplary embodiment of the present invention.

FIG. 2 It depicts a schematic diagram illustrating examples of purchasing contexts.

FIG. 3 It depicts a schematic diagram illustrating examples of purchasing contexts.

FIG. 4 It depicts a schematic diagram illustrating examples of correspondences between a purchasing context ID and a customer ID.

FIG. 5 It depicts a schematic diagram illustrating examples of correspondences between a purchasing context ID and a store ID.

FIG. 6 It depicts a schematic diagram illustrating examples of correspondences among a purchasing context ID, a customer ID, and a store ID.

FIG. 7 It depicts a schematic diagram illustrating an example of a customer master.

FIG. 8 It depicts a schematic diagram illustrating an example of a store master.

FIG. 9 It depicts a schematic diagram illustrating an example of a product master.

FIG. 10 It depicts a schematic diagram illustrating a state in which a purchasing context ID, a product ID, and a customer ID before grouping are arranged in order.

FIG. 11 It depicts an explanatory diagram schematically illustrating an example of a purchasing context group, a product group, and a customer group determined by an inference means.

FIG. 12 It depicts an explanatory diagram schematically illustrating an example of a determination result of a purchasing context group, a product group, and a store group.

FIG. 13 It depicts an explanatory diagram schematically illustrating an example of a determination result of a purchasing context group, a product group, a customer group, and a store group.

FIG. 14 It depicts a flowchart illustrating an example of processing progress of the first exemplary embodiment.

FIG. 15 It depicts a block diagram illustrating a configuration example of a grouping system in a second exemplary embodiment of the present invention.

FIG. 16 It depicts a schematic diagram illustrating an example of distribution determined in accordance with groups.

FIG. 17 It depicts an explanatory diagram schematically illustrating an example of a product group determined by a recommendation target determination means 6.

FIG. 18 It depicts a flowchart illustrating an example of processing progress of the second exemplary embodiment.

FIG. 19 It depicts a schematic block diagram illustrating a configuration example of a computer according to each exemplary embodiment of the present invention.

FIG. 20 It depicts a block diagram illustrating an outline of a grouping system of the present invention.

FIG. 21 It depicts a block diagram illustrating an outline of a recommended-product determination system of the present invention.

### DESCRIPTION OF EMBODIMENTS

Hereinafter, exemplary embodiments of the present invention will be described with reference to the drawings.

First, a purchasing context will be described. The “purchasing context” is information indicating one or more types of products purchased in one purchasing activity. Here, the “one purchasing activity” means an entire purchasing activity during one visit to one store.

In addition, information indicating one or more types of products purchased with one monetary payment is referred to as a transaction. The transaction is typically represented in a receipt issued as a result of the monetary payment. Therefore, as a transaction ID for identifying the transaction, a receipt ID for identifying the receipt can be used. In addition, the transaction can also be referred to as receipt information.

A relationship between the one purchasing activity and the monetary payment varies depending on a store form. For example, when the store form is a convenience store, the monetary payment is performed once in one purchasing activity in the convenience store. Therefore, when the store form is the convenience store, the transaction corresponds to the purchasing context, and the receipt ID can be used as a purchasing context ID for identifying the purchasing context.

In addition, when the store form is a department store, a customer purchases products at various departments in one store (department store), and pays money for each department. Therefore, when the store form is the department store, a set of transactions for each department during one visit to the department store corresponds to the purchasing context. In this case, by assigning one purchasing context ID to a set of transactions resulting from purchasing of products at respective departments by the same customer (in other words, a set of pieces of receipt information), the purchasing context is identified. As such purchasing context ID in the department store, a combination of a customer ID and a purchasing date of the products at the department store by the customer may be used. Incidentally, when the customer is a member of the department store and the department store manages the customer ID, the department store can associate each transaction with the customer ID. Therefore, the department store can assign one purchasing context ID to a set of transactions resulting from purchasing of products at respective departments in the department store by the same customer.

### First Exemplary Embodiment

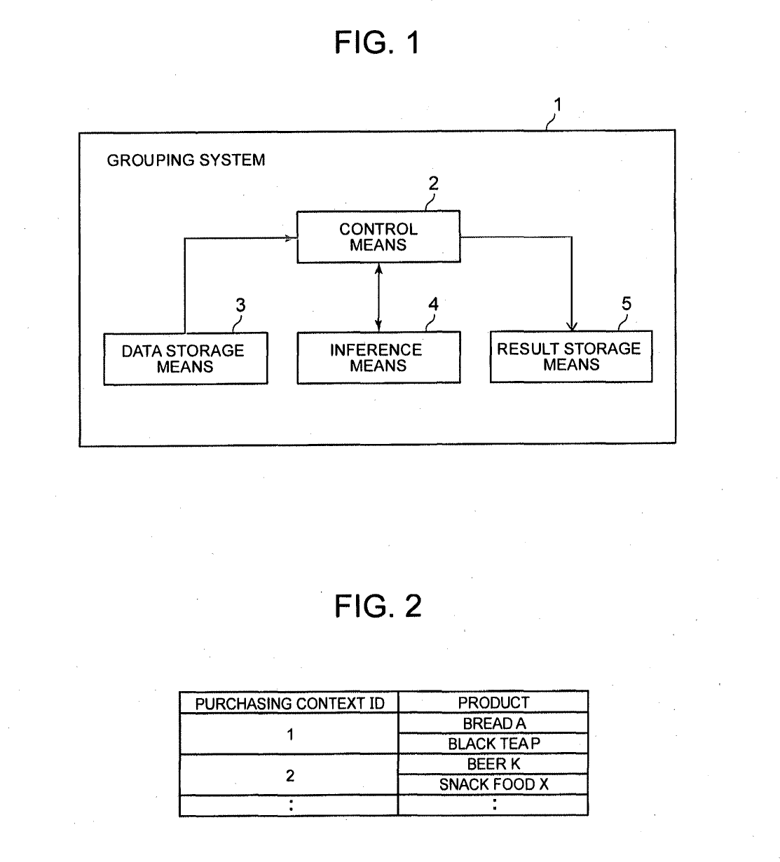

FIG. 1 depicts a block diagram illustrating a configuration example of a grouping system in a first exemplary embodiment of the present invention. A grouping system 1 of the present invention includes a control means 2, a data storage means 3, an inference means 4, and a result storage means 5.

Hereinafter, a case will be described where a customer purchases a product at a convenience store, and a receipt ID is used as a purchasing context ID, as an example. When the store is a department store, an ID assigned to a set of transactions for each department during one visit to the department store by one customer may be used as the purchasing context ID.

The data storage means 3 is a storage device that stores at least a purchasing context. Multiple purchasing contexts collected in advance are stored in the data storage means 3. FIG. 2 depicts a schematic diagram illustrating examples of purchasing contexts. In the examples illustrated in FIG. 2, examples are illustrated of purchasing contexts obtained from a result of purchasing activity at the convenience store by various customers. Each product associated with one purchasing context ID represents a product purchased in one purchasing activity. For example, a purchasing context ID “1” exemplified in FIG. 2 is associated with a “bread A” and a “black tea P”. This indicates that there is a result of purchasing of the “bread A” and the “black tea P” in one purchasing activity by one customer. Incidentally, the “bread A” or the like indicated as a product in FIG. 2 is a product name; however, the product may be represented by the product ID in the purchasing context.

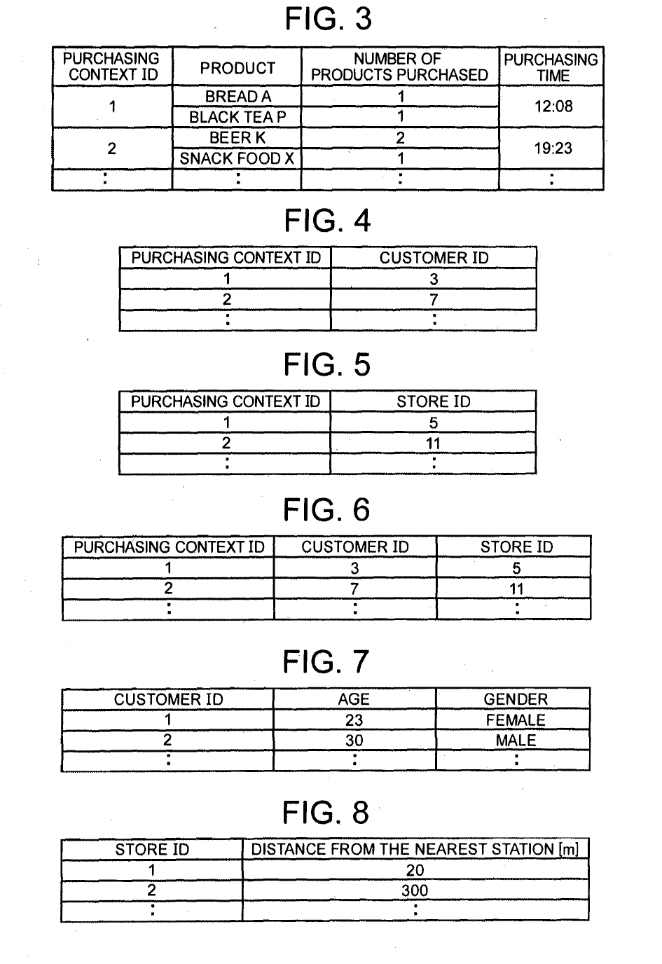

In addition, in the purchasing context exemplified in FIG. 2, specific information indicating the purchasing result may be associated with each product. FIG. 3 illustrates examples of purchasing contexts in this case. In the example illustrated in FIG. 3, as information illustrating the purchasing result, the number of products purchased is associated with the product. As the information indicating the purchasing result, a purchasing amount of money for each product may be used.

In addition, as exemplified in FIG. 3, information of purchasing time may be associated with each purchasing context. The purchasing time is, for example, purchasing time recorded on the receipt. In the purchasing context in the department store, for example, average time of the purchasing time recorded in each receipt may be associated with the purchasing context. The purchasing time can be said to be an attribute of the purchasing context.

In addition, the data storage means 3 may store a correspondence between a purchasing context ID and a customer ID. FIG. 4 depicts a schematic diagram illustrating examples of correspondences between the purchasing context ID and the customer ID. When the customer is a member of the store and the store manages the customer ID, the store can associate the purchasing context ID and the customer ID with each other. Such information may be stored in the data storage means 3. The fact that the purchasing context ID and the customer ID are associated with each other indicates that there is a purchasing fact of purchasing by the customer.

In addition, the data storage means 3 may store a correspondence between a purchasing context ID and a store ID. FIG. 5 depicts a schematic diagram illustrating examples of correspondences between the purchasing context ID and the store ID. The fact that the purchasing context ID and the store ID are associated with each other indicates that there is a purchasing fact at the store.

In addition, the data storage means 3 may store a correspondence among a purchasing context ID, a customer ID, and a store ID. FIG. 6 depicts a schematic diagram illustrating examples of correspondences among the purchasing context ID, the customer ID, and the store ID. The fact that the purchasing context ID, the customer ID, and the store ID are associated with each other indicates that there is a purchasing fact of purchasing at the store by the customer.

In addition, the data storage means 3 may store a customer master that is information associating a customer ID and an attribute of the customer with each other. FIG. 7 depicts a schematic diagram illustrating an example of the customer master. In FIG. 7, the customer master in which the customer ID is associated with an age and a gender of the customer is exemplified; however, the customer ID may be associated with only the age, or the customer ID may be associated with only the gender.

In addition, the data storage means 3 may store a store master that is information associating a store ID and an attribute of the store associated with each other. FIG. 8 depicts a schematic diagram illustrating an example of the store master. In FIG. 8, the store master is exemplified in which the store ID is associated with a distance to the store from the nearest station of the store.

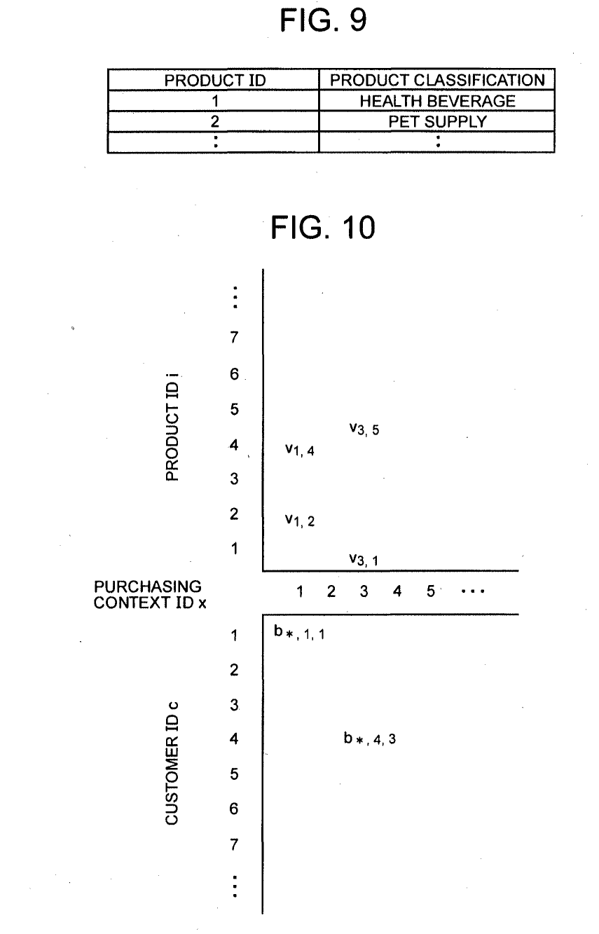

In addition, the data storage means 3 may store a product master associating a product ID and a product classification of the product. FIG. 9 depicts a schematic diagram illustrating an example of the product master. The product classification can be said to be an attribute of the product.

Incidentally, the information to be stored in the data storage means 3 only needs to be obtained from each store by an analyst, and stored in the data storage means 3 in advance by the analyst. In addition, the analyst may be an employee of a company managing multiple stores.

The control means 2 controls the grouping system 1. Specifically, the control means 2 sends the information stored in the data storage means 3 to the inference means 4, and causes the inference means 4 to perform grouping of product IDs, grouping of purchasing context IDs, and the like. The control means 2 stores an execution result of processing of the inference means 4 in the result storage means 5.

The result storage means 5 is a storage device that stores the execution result of the processing of the inference means 4.

The inference means 4 uses the information stored in the data storage means 3 to determine at least a group of the product IDs and a group of the purchasing context IDs. In addition, the inference means 4, when determining the group of the product IDs and the group of the purchasing context IDs, may determine either or both of a group of the customer IDs and a group of the store IDs, simultaneously.

Hereinafter, the group of the product IDs may be simply referred to as a product group. The same applies to the group of the purchasing context IDs, the group of the customer IDs, and the group of the store IDs.

Hereinafter, to simplify the description, a case will be described where the inference means 4 determines a product group and a purchasing context group so that each product ID belongs to only one product group and each purchasing context ID belongs to one purchasing context group, as an example. In addition, in the following description, it is assumed that the inference means 4, also when determining a customer group and a store group, determines the customer group and the store group so that each customer ID belongs to only one customer group and each store ID belongs to only one store group. Incidentally, determining a group so that one element belongs to only one group in this way is referred to as clustering.

The purchasing context ID is represented by a reference sign “x”. In addition, a purchasing context with purchasing context ID “x” is referred to as a purchasing context “x”.

The product ID is represented by a reference sign “i”. In addition, a product with product ID “i” is referred to as a product “i”.

The customer ID is represented by a reference sign “c”. In addition, a customer with customer ID “c” is referred to as a customer “c”.

The store ID is represented by a reference sign “s”. In addition, a store with store ID “s” is referred to as a store “s”.

In addition, a purchasing result corresponding to the purchasing context “x” and one of products corresponding to the purchasing context “x” is referred to as v_{x,i}. For example, it is assumed that the purchasing result is represented by the number of products purchased as illustrated in FIG. 3. Then, it is assumed that the product ID of the “bread A” illustrated in FIG. 3 is “11”, and the product ID of the “black tea P” is “9”. The purchasing results (the number of products purchased) of the “bread A” and the “black tea P” in the purchasing context “1” are each “1”, so that v_{1,11}=1 and v_{1,9}=1. Incidentally, as described above, the purchasing result may be the purchasing amount of money for each product. In addition, the purchasing result may be represented by a binary value (0 or 1), and the fact that there is a purchasing result may be represented by “1” and the fact that there is no purchasing result may be represented by “0”. For example, the purchasing result may be represented as v_{x,i}=1 or v_{x,i}=0.

In addition, presence of the purchasing fact is represented by b_{s,c,x}. The binary value 0 or 1 represents b_{s,c,x}. Suffixes s, c, x in b_{s,c,x} represent the store ID, the customer ID, the purchasing context ID, respectively. When the purchasing context ID “x” occurs due to purchasing by the customer “c” at the store “s”, b_{s,c,x}=1, and when such a fact does not exist, b_{s,c,x}=0. In other words, as exemplified in FIG. 6, when information indicating the correspondence among the purchasing context ID, the customer ID, and the store ID exists, b_{s,c,x}=1, and when the information indicating the correspondence does not exist, b_{s,c,x}=0. In the example of the first line illustrated in FIG. 6, b_{5,3,1}=1.

In addition, when it is represented whether or not the purchasing context ID “x” occurs due to purchasing by the customer “c” without focusing on the store, the suffix s in b_{s,c,x} is referred to as “*”. For example, as exemplified in FIG. 4, it is assumed that only the correspondence between the purchasing context ID and the customer ID is indicated. In this case, the presence of the purchasing fact is represented by b_{*,c,x}. Then, when information indicating the correspondence between the purchasing context ID and the customer ID exists, b_{*,c,x}=1, and when the information indicating the correspondence does not exist, b_{*,c,x}=0. In the example of the first line illustrated in FIG. 4, b_{*,3,1}=1.

Similarly, when it is represented whether or not the purchasing context ID “x” occurs due to purchasing activity at the store “s” without focusing on the customer, the suffix c in b_{s,c,x} is referred to as “*”. For example, as exemplified in FIG. 5, it is assumed that only the correspondence between the purchasing context ID and the store ID is indicated. In this case, the presence of the purchasing fact is represented by b_{s,*,x}. Then, when information indicating the correspondence between the purchasing context ID and the store ID exists, b_{s,*,x}=1, and when the information indicating the correspondence does not exist, b_{s,*,x}=0. In the example of the first line illustrated in FIG. 5, b_{5,*,1}=1.

Hereinafter, group determination operation by the inference means 4 is schematically shown. A specific arithmetic operation during determination of the group by the inference means 4 will be described later.

To simplify the description, first, a case is schematically shown where the inference means 4 determines the purchasing context group, the product group, and the customer group simultaneously, for the purchasing context ID, the product ID, and the customer ID. In this case, the information exemplified in FIGS. 5 and 6 does not have to be stored in the data storage means 3. However, the information exemplified in FIG. 4 (that is, information indicating the correspondence between the purchasing context ID and the customer ID) is necessary.

FIG. 10 illustrates a state in which the purchasing context ID, the product ID, and the customer ID before grouping are arranged in order. In FIG. 10, a relationship between the purchasing context ID and the product ID is indicated in the upper half, and a relationship between the purchasing context ID and the customer ID is indicated in the lower half. In addition, in FIG. 10, a state is indicated in which the purchasing context IDs are arranged in order in the horizontal direction, and the product IDs and the customer IDs are each arranged in order in the vertical direction. In addition, for each combination of a purchasing context ID and each product ID corresponding to the purchasing context ID, a purchasing result v_{x,i} of the product is illustrated. For example, v_{1,2} illustrated in FIG. 10 is the number of products purchased of the product “2” purchased by the customer in the purchasing activity corresponding to the purchasing context ID “1”, and v_{1,4} is the number of products purchased of the product “4” purchased by the customer simultaneously. In addition, on the basis of the correspondence between the purchasing context ID and the customer ID, customer's purchasing fact b_{*,c,x} is illustrated. In this example, since the inference means 4 does not determine the group of the store IDs, the inference means 4 does not focus on the store ID. For that reason, b_{s,c,x} is referred to as b_{*,c,x}. Values of b_{*,1,1} and b_{*,4,3} illustrated in FIG. 10 are each 1, and the facts are indicated that the customer “1” has performed the purchasing activity corresponding to the purchasing context ID “1”, and the customer “4” has performed the purchasing activity corresponding to the purchasing context ID “1”. Incidentally, b_{*,c,x} exists for each set of the purchasing context ID and the customer ID, and its value is 0 or 1.

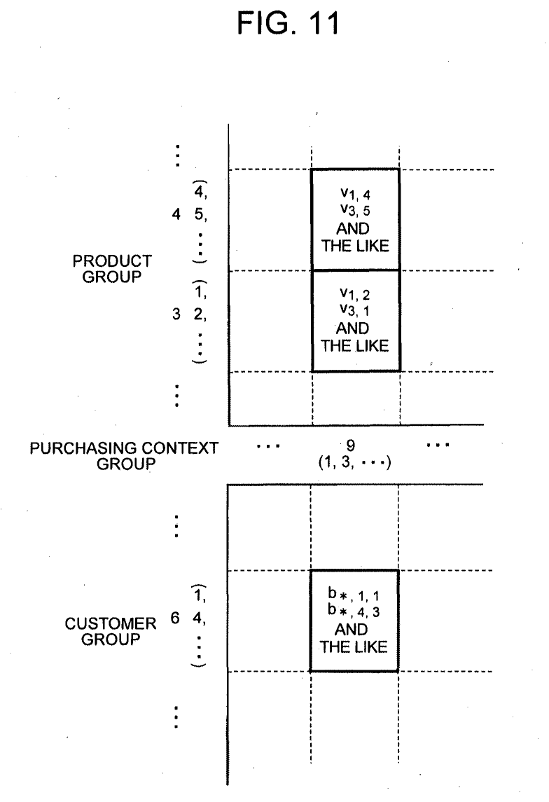

FIG. 11 depicts an explanatory diagram schematically illustrating an example of the purchasing context group, the product group, and the customer group determined by the inference means 4. The inference means 4 determines multiple purchasing context groups, product groups, and customer groups. However, in FIG. 11, to simplify the description, only the purchasing context group with ID “9”, the product groups with IDs “3”, “4”, and the customer group with ID “6” are illustrated. The number of purchasing context groups, the number of product groups, and the number of customer groups may be each determined to a fixed value, or does not have to be limited to the fixed value. It is assumed that the number of purchasing context groups is K^{X}, and IDs of purchasing context groups are 1 to K^{X}. It is assumed that the number of product groups is K^{I}, and IDs of the product groups are 1 to K^{I}. It is assumed that the number of customer groups is K^{C}, and IDs of the customer groups are 1 to K^{C}. In addition, when the ID of the purchasing context group is “k” (k is any of 1 to K^{X}), the purchasing context group is referred to as a purchasing context group “k”. This point also applies to the product group and the customer group, and the store group described later.

In addition, in the example illustrated in FIG. 11, the purchasing context ID, the product ID, and the customer ID belonging to the respective groups are indicated in parentheses. For example, the purchasing context IDs “1”, “3”, and the like belong to the purchasing context group “9”. The product IDs “1”, “2”, and the like belong to the product group “3”, and the product IDs “4”, “5”, and the like belong to the product group “4”. In addition, the customer IDs “1”, “4”, and the like belong to the customer group “6”.

A combination of one purchasing context group and one product group corresponds to a purchasing result (in this example, the number of products purchased) v_{x,i} according to a combination of a purchasing context ID belonging to the purchasing context group and a product ID belonging to the product group. For example, in the example illustrated in FIG. 11, the combination of the purchasing context group “9” and the product group “2” corresponds to v_{1,2}, v_{3,1}, and the like. In this example, the number of products purchased is used as the purchasing result, so that the purchasing result is referred to as the number of products purchased.

In addition, a combination of one purchasing context group and one customer group corresponds to a purchasing fact b_{*,c,x} according to a combination of a purchasing context ID belonging to the purchasing context group and a customer ID belonging to the customer group. For example, in the example illustrated in FIG. 11, the combination of the purchasing context group “9” and the customer group “6” corresponds to b_{*,1,1}, b_{*,4,3}, and the like.

From distribution of v_{x,i} corresponding to the combination of one purchasing context group and one product group, the analyst can determine whether or not many products belonging to the product group have been purchased. Therefore, the analyst can refer to the distribution of v_{x,i} for each combination of one purchasing context group and each product group, to specify a product group of which many products have been purchased. Then, the analyst can specify product groups likely to be simultaneously purchased, by specifying multiple product groups that are multiple product groups corresponding to a common purchasing context group and of which it is determined that many products have been purchased from the distribution of v_{x,i}. For example, it is assumed that, from the distribution of v_{x,i} in the combination of the purchasing context group “9” and the product group “3”, and the distribution of v_{x,i} in the combination of the purchasing context group “9” and the product group “4”, the analyst determines that many products of the product groups “3”, “4” have been purchased when the product groups correspond to the purchasing context group “9”. In this case, the analyst can obtain an analysis result that a product belonging to the product group “3” and a product belonging to the product group “4” are likely to be simultaneously purchased.

In addition, from distribution of b_{*,c,x} corresponding to the combination of one purchasing context group and one customer group, the analyst can specify a customer group that is a customer group corresponding to one purchasing context group and has many purchasing facts. For example, the analyst can determine that there are many purchasing facts in the customer group “6” regarding the combination with the purchasing context group “9”, and the like.

Therefore, the analyst can analyze products likely to be simultaneously purchased and the product groups to which the products belong, and further can specify a customer group having such a purchasing tendency. In the above example, the analyst can analyze that a product belonging to the product group “3” and a product belonging to the product group “4” are likely to be simultaneously purchased, and a customer belonging to the customer group “6” has such a tendency.

Incidentally, it can be said that FIG. 11 is a diagram modified from FIG. 10 so that purchasing context IDs belonging to the same purchasing context group are continuously arranged, product IDs belonging to the same product group are continuously arranged, and customer IDs belonging to the same customer group are continuously arranged.

In the examples illustrated in FIGS. 10 and 11, a case has been schematically shown where the inference means 4 determines the purchasing context group, the product group, and the customer group. The inference means 4 determines at least the purchasing context group and the product group, and does not have to determine the customer group. That is, the inference means 4 determines the purchasing context group and the product group schematically illustrated in FIG. 11, and does not have to determine the customer group schematically illustrated in FIG. 11. In this case, the information indicating the correspondence between the purchasing context ID and the customer ID or the store ID (information exemplified in FIGS. 5, 6, and 7) does not have to be stored in the data storage means 3.

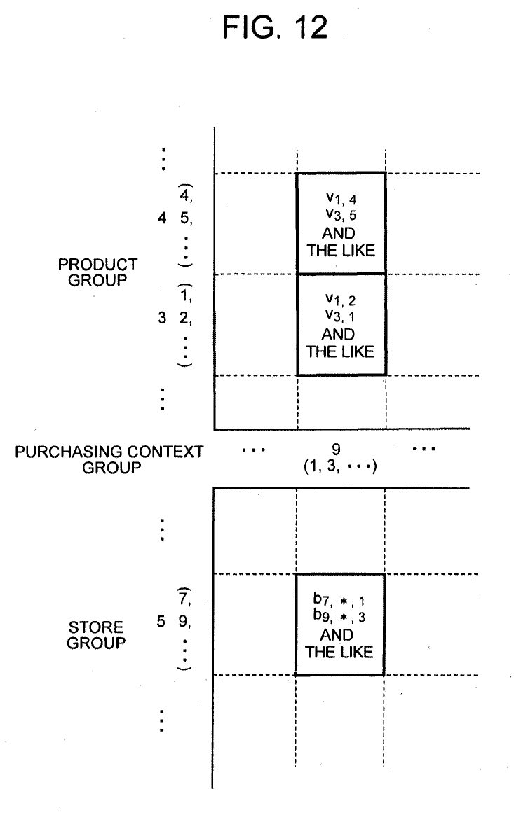

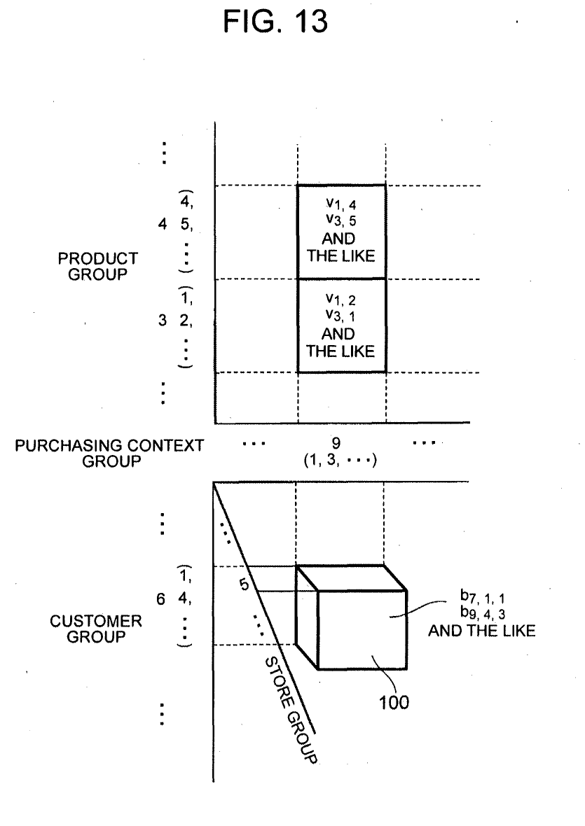

In addition, the inference means 4 may determine the purchasing context group, the product group, and the store group simultaneously, for the purchasing context ID, the product ID, and the store ID. In this case, the information exemplified in FIGS. 4 and 6 does not have to be stored in the data storage means 3. However, the information exemplified in FIG. 5 (that is, information indicating the correspondence between the purchasing context ID and the store ID) is necessary. FIG. 12 depicts an explanatory diagram schematically illustrating an example of a determination result of the purchasing context group, the product group, and the store group. A purchasing fact b_{s,*,x} illustrated in FIG. 12 represents a purchasing fact in a store without focusing on a customer.

From distribution of b_{s,*,x} corresponding to a combination of one purchasing context group and one store group, the analyst can specify a store group that is a store group corresponding to one purchasing context group and has many purchasing facts. For example, the analyst can determine that there are many purchasing facts in the store group “5” regarding the combination with the purchasing context group “9”, and the like. Therefore, the analyst can analyze products likely to be simultaneously purchased and the product groups to which the products belong, and further can specify a store group showing such a purchasing tendency.

In addition, the inference means 4 may determine the purchasing context group, the product group, the customer group, and the store group simultaneously, for the purchasing context ID, the product ID, the customer ID, and the store ID. In this case, as exemplified in FIG. 6, the information indicating the correspondence among the purchasing context ID, the customer ID, and the store ID is stored in advance in the data storage means 3. In this case, whether or not the purchasing context ID “x” occurs due to purchasing by the customer “c” at the store “s” can be represented by b_{s,c,x}. FIG. 13 depicts an explanatory diagram schematically illustrating an example of a determination result of the purchasing context group, the product group, the customer group, and the store group. As illustrated in FIG. 13, an axis indicating the purchasing context group, an axis indicating the product group, and an axis indicating the store group can be considered, and a region according to a combination of one purchasing context group, one customer group, and one store group can be defined in a space defined by the three axes. In FIG. 13, a region 100 according to the combination of the purchasing context group “9”, the customer group “6”, and the store group “5” is exemplified. Such individual region corresponds to a set of b_{s,c,x} indicating whether or not a customer has shopped at a store. In the example illustrated in FIG. 13, a case is exemplified where the region 100 corresponds to b_{7,1,1}, b_{9,4,3}, and the like. Incidentally, only the region 100 is illustrated in FIG. 13, but a similar region exists for each combination of one purchasing context group, one customer group, and one store group, in the space defined by the three axes.

The inference means 4 determines the purchasing context group, the product group, the customer group, and the store group as schematically illustrated in FIG. 13, whereby the analyst can analyze products likely to be simultaneously purchased and the product groups to which the products belong, and further can specify a customer group and a store group showing such a purchasing tendency.

In addition, the inference means 4, when determining the various groups, may use the purchasing time associated with the purchasing context ID (see FIG. 3).

In addition, the inference means 4, when determining the various groups, may use the attribute of the customer (for example, one or both of the age and the gender).

In addition, the inference means 4, when determining the various groups, may use the attribute of the store (for example, the distance to the store from the nearest station of the store).

In addition, the inference means 4, when determining the various groups, may use the attribute of the product (for example, the product classification).

Hereinafter, the arithmetic operation during determination of the group by the inference means 4 will be described. In the following description, a case will be described where the inference means 4 determines the purchasing context group, the product group, the customer group, and the store group, as an example. In addition, a case will be described where, at this time, the inference means 4 also uses the purchasing time associated with the purchasing context ID, the age and the gender of the customer, the distance to the store from the nearest station of the store, and the product classification, to determine each group, as an example.

Here, the purchasing context group to which the purchasing context “x” belongs is referred to as z^{X}ₓ. For example, when the ID of the purchasing context group to which the purchasing context “1” belongs is “3”, it can be represented as z^{X}₁=3. In addition, z^{X}ₓ may be represented by a vector in which only an element corresponding to the purchasing context group ID is 1 and other elements are 0. For example, in the above example, it may be represented as z^{X}₁=(0, 0, 1, 0, 0, . . . )^{T}.

In addition, the product group to which the product “i” belongs is referred to as z^{I}ᵢ. For example, when the ID of the product group to which the product “2” belongs is “4”, it can be represented as z^{I}₂=4. In addition, z^{I}₁ may be represented by a vector in which only an element corresponding to the product group ID is 1 and other elements are 0. For example, in the above example, it may be represented as z^{I}₂=(0, 0, 0, 1, 0, . . . )^{T}.

In addition, the customer group to which the customer “c” belongs is referred to as z^{C}_{c}. For example, when the ID of the customer group to which the customer “3” belongs is “1”, it can be represented as z^{C}₃=1. In addition, z^{C}_{c} may be represented by a vector in which only an element corresponding to the customer group ID is 1 and other elements are 0. For example, in the above example, it may be represented as z^{C}₃=(1, 0, 0, 0, 0, . . . )^{T}.

In addition, the store group to which the store “s” belongs is referred to as z^{S}ₛ. For example, when the ID of the store group to which the store “2” belongs is “3”, it can be represented as z^{S}₂=3. In addition, z^{S}ₛ may be represented by a vector in which only an element corresponding to the ID of the store group is 1 and other elements are 0. For example, in the above example, it may be represented as z^{S}₂=(0, 0, 1, 0, 0, . . . )^{T}. Incidentally, it is assumed that the number of store groups is K^{S}, and IDs of the store groups are 1 to K^{S}.

In addition, a probability that the number of products purchased v_{x,i} occurs under a predetermined condition is referred to as p(v_{x,i}). Specifically, p(v_{x,i}) is represented as Expression (1) below.

p(v_{x,i})=p(v_{x,i}|θ,z^{X}ₓ,z^{I}ᵢ) Expression (1)

In Expression (1), θ is a set of distribution parameters of the number of products purchased, and includes K^{X}×K^{I} parameters as combinations of K^{X} purchasing context groups and K^{I} product groups. Expression (1) represents that an occurrence probability of v_{x,i} is determined by a distribution parameter of the number of products purchased corresponding to a combination of the purchasing context group “z^{X}ₓ” to which the purchasing context “x” belongs and the product group “z^{I}ᵢ” to which the product “i” belongs, of the parameter set θ. That is, p(v_{x,i}) is a probability that v_{x,i} occurs under such a distribution parameter. Incidentally, as distribution of the number of products purchased, for example, Poisson distribution may be used. In addition, when the purchasing result v_{x,i} is represented by the purchasing amount of money, as distribution of the purchasing amount of money, for example, Gauss distribution may be used.

In addition, a probability that the purchasing context “x” occurs due to purchasing at the store “s” by the customer “c” under a predetermined condition is referred to as p(b_{s,c,x}). In other words, p(b_{s,c,x}) is a probability that b_{s,c,x}=1 under a predetermined condition. Specifically, p(b_{s,c,x}) is represented as Expression (2) below.

p(b_{s,c,x})=p(b_{s,c,x}|ϕ),z^{S}ₛ,z^{C}_{c},z^{X}ₓ) Expression (2)

In Expression (2), ϕ is a set of distribution parameters of the presence of the purchasing fact, and includes K^{S}× K^{C}× K^{X} parameters as combinations of K^{S} store groups, K^{C} customer groups, and K^{X} purchasing context groups. Expression (2) represents that an occurrence probability of b_{s,c,x} is determined by a parameter of distribution of b_{s,c,x} (distribution of the presence of the purchasing fact) corresponding to a combination of the store group “z^{S}s” to which the store “s” belongs, the customer group “z^{C}_{c}” to which the customer “c” belongs, and the purchasing context group “z^{X}ₓ” to which the purchasing context “x” belongs, of the set. That is, p(b_{s,c,x}) is a probability that b_{s,c,x}=1 under such a distribution parameter. Incidentally, as the distribution of b_{s,c,x}, for example, Bernoulli distribution may be used.

Incidentally, when the store is not focused, z^{S}ₛ may be excluded in Expression (2). In that case, a distribution parameter of b_{*,c,x} corresponding to a combination of the customer group “z^{C}_{c}” and the purchasing context group “z^{X}ₓ” may be used as ϕ. Similarly, when the customer is not focused, z^{C}_{c} may be excluded in Expression (2). In that case, a distribution parameter of b_{s,*,x} corresponding to a combination of the store group “z^{S}ₛ” and the purchasing context group “z^{X}ₓ” may be used as ϕ.

In addition, purchasing time corresponding to the purchasing context “x” is tₓ. A probability that tₓ occurs under a predetermined condition is referred to as p(tₓ). Specifically, p(tₓ) is represented as Expression (3) below.

p(tₓ)=p(tₓ|γ,z^{X}ₓ) Expression (3)

In Expression (3), γ is a set of distribution parameters of the purchasing time, and includes parameters of K^{X} purchasing context groups. Expression (3) represents that an occurrence probability of tₓ is determined by a distribution parameter of the purchasing time corresponding to the purchasing context group “z^{X}ₓ” to which the purchasing context “x” belongs, of the set. That is, p(tₓ) is a probability that tₓ occurs under such a distribution parameter. As distribution of the purchasing time, for example, Von Mises distribution or Gauss distribution, or the like may be used.

A distance to the store “s” from the nearest station of the store “s” is dₛ. A probability that dₛ occurs under a predetermined condition (in other words, a probability that the distance to the store “s” from the nearest station is dₛ) is referred to as p(dₛ). Specifically, p(dₛ) is represented as Expression (4) below.

p(dₛ)=p(dₛ|δ,z^{S}ₛ) Expression (4)

In Expression (4), δ is a set of distribution parameters of the distance to the store from the nearest station of the store, and includes parameters of K^{S} store groups. Expression (4) represents that an occurrence probability of dₛ is determined by a distribution parameter of the distance corresponding to the store group “z^{S}ₛ” to which the store “s” belongs, of the set. The distance means a distance to the store from the nearest station of the store. That is, p(dₛ) is a probability that dₛ occurs under such a distribution parameter. As distribution of the distance, for example, Gauss distribution may be used.

A gender of the customer “c” is g_{c}. A probability that g_{c} occurs under a predetermined condition (in other words, a probability that the gender of the customer “c” is g_{c}) is referred to as p(g_{c}). Specifically, p(g_{c}) is represented as Expression (5) below.

p(g_{c})=p(g_{c}|ψ,z^{C}_{c}) Expression (5)

In Expression (5), ψ is a set of distribution parameters of the gender, and includes parameters of K^{C} customer groups. Expression (5) represents that g_{c} is determined by a distribution parameter of the gender corresponding to the customer group “z^{C}_{c}” to which the customer “c” belongs, of the set. That is, p(g_{c}) is a probability that g_{c} occurs under such a distribution parameter. As distribution of the gender, for example, Bernoulli distribution may be used.

An age of the customer “c” is a_{c}. A probability that a_{c} occurs under a predetermined condition (in other words, a probability that the age of the customer “c” is a_{c}) is referred to as p(a_{c}). Specifically, p(a_{c}) is represented as Expression (6) below.

p(a_{c})=p(a_{c}|α,z^{C}_{c}) Expression (6)

In Expression (6), α is a set of distribution parameters of the age of the customer, and includes parameters of K^{C} customer groups. Expression (6) represents that a_{c} is determined by a distribution parameter of the age corresponding to the customer group “z^{C}_{c}” to which the customer “c” belongs, of the set. That is, p(a_{c}) is a probability that a_{c} occurs under such a distribution parameter. As distribution of the age, for example, Gauss distribution may be used.

A product classification of the product “i” is uᵢ. A probability that uᵢ occurs under a predetermined condition (in other words, probability that the product classification of the product “i” is uᵢ) is referred to as p(uᵢ). Specifically, p(uᵢ) is represented as Expression (7) below.

p(uᵢ)=p(uᵢ|η,z^{I}ᵢ) Expression(7)

In Expression (7), η is a set of distribution parameters of the product classification, and includes parameters of K^{I} product groups. Expression (7) represents that uᵢ is determined by a distribution parameter of the product classification corresponding to the product group “z^{I}ᵢ” to which the product “i” belongs, of the set. That is, p(uᵢ) is a probability that uᵢ occurs under such a distribution parameter. As distribution of the product classification, for example, the multinomial distribution may be used.

Incidentally, the distribution parameter only needs to be a parameter according to a type of the distribution. For example, parameters of Gauss distribution are a mean and a variance.

The inference means 4 uses Expression (8) shown below.

$$\begin{matrix}[ Mathematical Expression 1 ] & \\ {\prod }_{s ∈ {S}_{s}}^{ } {\prod }_{c ∈ {S}_{c}}^{ } {\prod }_{x ∈ {S}_{x}} {\prod }_{i ∈ {S}_{i}}^{ } p ( {v}_{x , i} , {b}_{s , c , x} , {t}_{x} , {d}_{s} , {g}_{c} , {a}_{c} , {u}_{i} \vert θ , φ , γ , δ , ψ , α , η , {z}_{s}^{S} , {z}_{c}^{C} , {z}_{x}^{X} , {z}_{i}^{I} ) & Expression ( 8 )\end{matrix}$$

Expression (8) is a likelihood of a combination of the store groups to which each store ID belongs, the customer groups to which each customer ID belongs, the purchasing context groups to which each purchasing context ID belongs, the product groups to which each product ID belongs, and the above-described distribution parameters θ, ϕ, γ, δ, ψ, α, η.

In addition, in Expression (8), Sₛ is a set of the store IDs. Similarly, S_{c} is a set of the customer IDs, and Sₓ is a set of the purchasing context IDs, and Sᵢ a set of the product IDs.

In Expression (8), p(v_{x,i}, b_{s,c,x}, tₓ, dₛ, g_{c}, a_{c}, uᵢ|θ, ϕ, γ, δ, ψ, α, η, z^{S}ₛ, z^{C}_{c}, z^{X}ₓ, z^{I}ᵢ) is a probability that v_{x,i}, b_{s,c,x}, tₓ, dₛ, g_{c}, a_{c}, uᵢ occur under distribution parameters θ, ϕ, γ, δ, ψ, α, η.

The inference means 4 uses the likelihood calculated by Expression (8) to determine each purchasing context group, each product group, each customer group, and each store group. At this time, the inference means 4 also determines various distribution parameters. The inference means 4 determines the distribution parameter of the number of products purchased θ for each combination of the purchasing context group and the product group. In addition, the inference means 4 determines the distribution parameter of the presence of the purchasing fact ϕ for each combination of the store group, the customer group, and the purchasing context group. In addition, the inference means 4 determines the distribution parameter of the purchasing time γ for each purchasing context group. In addition, the inference means 4 determines the distribution parameter of the distance δ for each store group. In addition, the inference means 4 determines the distribution parameter of the gender ψ and the distribution parameter of the age α for each customer group. In addition, the inference means 4 determines the distribution parameter of the product classification η for each product group.

For example, the inference means 4 only needs to update z^{S}ₛ, z^{C}_{c}, z^{X}ₓ, z^{I}ᵢ, θ, ϕ, γ, δ, ψ, α, η in Expression (8) so that the likelihood calculated by Expression (8) increases, and determine each of the purchasing context groups, the product groups, the customer groups, the store groups, and the above various distribution parameters. In addition, for example, the inference means 4 may update z^{S}ₛ, z^{C}_{c}, z^{X}ₓ, z^{I}ᵢ, θ, ϕ, γ, δ, ψ, α, η, and determine each of the purchasing context groups, the product groups, the customer groups, the store groups, and the above various distribution parameters so that the likelihood calculated by Expression (8) becomes the maximum.

When updating the elements in Expression (8) as described above, when determining the various groups and the various parameters so that the likelihood becomes the maximum, or when including prior distribution in Expression (8) and estimating to maximize posterior distribution (MAP estimation), the inference means 4 may use the Expectation-Maximization (EM) method. In addition, when using the parameters in the expression as distribution and obtaining the posterior distribution, for example, the variational Bayesian method, or the Gibbs sampling method may be used.

The control means 2 and the inference means 4 are realized by a CPU of a computer, for example. In this case, the CPU only needs to read a grouping program from a program recording medium such as a program storage device of the computer (not illustrated in FIG. 1), and operate as the control means 2 and the inference means 4 in accordance with the grouping program.

In addition, the grouping system 1 may have a configuration in which two or more physically separated devices are connected together by wire or wirelessly. This point also applies to an exemplary embodiment described later.

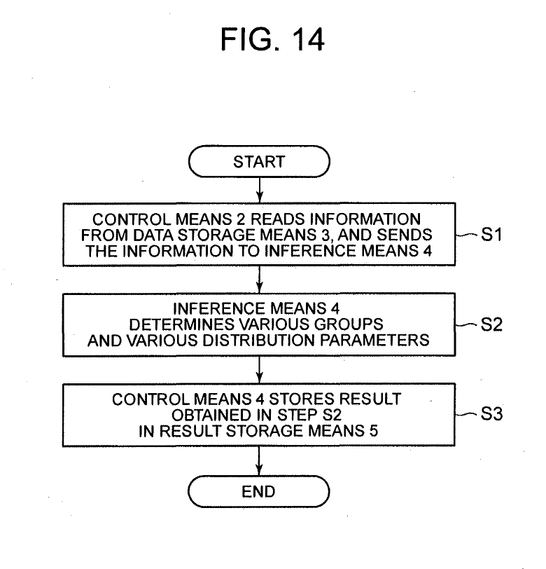

Next, processing progress will be described. FIG. 14 depicts a flowchart illustrating an example of processing progress of the first exemplary embodiment. It is assumed that in the data storage means 3, the purchasing context including the number of products purchased and the purchasing time as exemplified in FIG. 3, the information associating the purchasing context ID, the customer ID, and the store ID with each other as exemplified in FIG. 6, and the customer master, the store master, and the product master exemplified in FIGS. 7 to 9 are stored. The control means 2 reads each of these pieces of information from the data storage means 3, and sends the information to the inference means 4 (step S1).

The inference means 4 uses the information sent from the control means 2 in step S1 to determine various groups and various distribution parameters (step S2). The inference means 4 updates z^{S}ₛ, z^{C}_{c}, z^{X}ₓ, z^{I}ᵢ, θ, ϕ, γ, δ, ψ, α, η in Expression (8) so that the likelihood calculated by Expression (8) increases, and determines each of the purchasing context groups, the product groups, the customer groups, the store groups, and the various distribution parameters. As described above, the inference means 4 determines the distribution parameter set θ of the number of products purchased for each combination of the purchasing context group and the product group. In addition, the inference means 4 determines the distribution parameter set of the presence of the purchasing fact ϕ for each combination of the store group, the customer group, and the purchasing context group. In addition, the inference means 4 determines the distribution parameter set of the purchasing time γ for each purchasing context group. In addition, the inference means 4 determines the distribution parameter set of the distance δ for each store group. In addition, the inference means 4 determines the distribution parameter set of the gender ψ, and the distribution parameter set of the age α for each customer group. In addition, the inference means 4 determines the distribution parameter set of the product classification η for each product group.

The inference means 4 returns the product groups, the customer groups, the store groups, and the various distribution parameters determined in step S2, to the control means 2.

The control means 2 stores the customer groups, the store groups, and the various distribution parameters determined in step S2, in the result storage means 5 (step S3).

As a result, the purchasing context ID groups, the product groups, the customer groups, and the store groups as schematically illustrated in FIG. 13 are obtained.

As described above, from the distribution of v_{x,i} corresponding to the combination of one purchasing context group and one product group, the analyst can determine whether or not many products belonging to the product group have been purchased. Therefore, the analyst can analyze products likely to be simultaneously purchased and the product groups to which the products belong.

In addition, the analyst can specify the customer group and the store group having many purchasing facts, from the distribution of b_{s,c,x} corresponding to a combination of the purchasing context group, the customer group, and the store group. Therefore, the analyst can analyze products likely to be simultaneously purchased and the product groups to which the products belong, and further can specify customer group and store group showing such a purchasing tendency.

In addition, by including the purchasing time and its distribution parameter, the attribute of the product and its distribution parameter, the attribute of the customer and its distribution parameter, the attribute of the store and its distribution parameter, and the like in the expression for calculating the likelihood as illustrated in Expression (8), regarding to the various groups determined, more detailed information (information of distribution related to the attribute) can also be obtained.

In addition, by being able to perform such analysis, for example, a manufacturer developing a new product can analyze that an existing product of the manufacturer or a competing product is sold together with which product group, at which time zone, and to which customer group.

In addition, when a new product is released, on the basis of attribute information given to each product, the analyst can specify a product group to which the new product can be regarded to belong. Further, the analyst can specify a purchasing context group in which there is a strong tendency for the product group to be purchased, on the basis of a distribution parameter of the number of products purchased according to a combination of the product group and the purchasing context group. Further, the analyst can estimate that how many products are likely to be purchased at which store group, on the basis of a distribution parameter set of b_{s,c,x} according to a combination of the purchasing context group, the customer group, and the store group. Therefore, the analyst can estimate how many new products should be prepared at each store.

In addition, it is assumed that a store is newly provided. The analyst can refer to the attribute of the new store, to specify a store group to which the store can be regarded to belong. Further, the analyst can obtain a ratio of the purchasing context, for each combination of the store group and each purchasing context group. On the basis of this and a distribution parameter of the number of products purchased according to a combination of the purchasing context group and the product group, the analyst can estimate which product group's products are likely to be purchased a lot.

In the above example, a case has been described where the inference means 4 determines the purchasing context groups, the product groups, the customer groups, and the store groups, as an example. Hereinafter, a modification of operation of the inference means 4 will be described. Descriptions of the points already described will be omitted.

The inference means 4 may determine the purchasing context groups and the product groups without determining the customer group and the store group. In this case, the inference means 4 may use a likelihood calculated by Expression (9) below.

$$\begin{matrix}[ Mathematical Expression 2 ] & \\ {\prod }_{x ∈ {S}_{x}} {\prod }_{i ∈ {S}_{i}}^{ } p ( {v}_{x , i} , {t}_{x} , {u}_{i} \vert θ , γ , η , {z}_{x}^{X} , {z}_{i}^{I} ) & Expression ( 9 )\end{matrix}$$

Expression (9) is a likelihood of a combination of the purchasing context groups to which each purchasing context ID belongs, the product groups to which each product ID belongs, and the distribution parameter sets θ, γ, η. In Expression (9), p(v_{x,i}, tₓ, uᵢ|θ, γ, η, z^{X}ₓ, z^{I}ᵢ) is a probability that v_{x,i}, tₓ, uᵢ occur under distribution parameters θ, γ, η.

The inference means 4 only needs to update z^{X}ₓ, z^{I}ᵢ, θ, γ, η so that the likelihood increases, and determine the purchasing context groups, the product groups, and the distribution parameter sets θ, γ, η. As a result, the purchasing context ID groups and the product groups as schematically illustrated in the upper side of FIG. 11 are obtained, for example.

In addition, the inference means 4 may determine the purchasing context groups, the product groups, and the customer groups without determining the store group. In this case, the inference means 4 may use a likelihood calculated by Expression (10) below.

$$\begin{matrix}[ Mathematical Expression 3 ] & \\ {\prod }_{c ∈ {S}_{c}}^{ } {\prod }_{x ∈ {S}_{x}} {\prod }_{i ∈ {S}_{i}}^{ } p ( {v}_{x , i} , {b}_{⋆ , c , x} , {t}_{x} , {g}_{c} , {a}_{c} , {u}_{i} \vert θ , φ , γ , ψ , α , η , {z}_{c}^{C} , {z}_{x}^{X} , {z}_{i}^{I} ) & Expression ( 10 )\end{matrix}$$

Expression (10) is a likelihood of a combination of the customer groups to which each customer ID belongs, the purchasing context groups to which each purchasing context ID belongs, the product groups to which each product ID belongs, and the distribution parameter sets θ, ϕ, γ, ψ, α, η. In Expression (10), p(v_{x,i}, b_{*,c,x}, tₓ, g_{c}, a_{c}, uᵢ|θ, ϕ, γ, ψ, α, z^{C}_{c}, z^{X}ₓ, z^{I}ᵢ) is a probability that v_{x,i}, b_{*,c,x}, tₓ, g_{c}, a_{c}, uᵢ occur under distribution parameters θ, ϕ, γ, ψ, α, η.

The inference means 4 only needs to update z^{C}_{c}, z^{X}ₓ, z^{I}ᵢ, θ, ϕ, γ, ψ, α, η so that the likelihood increases, and determine the purchasing context groups, the product groups, customer groups, and the distribution parameter sets θ, ϕ, γ, ψ, α, η. As a result, the purchasing context ID groups, the product groups, and the customer groups as schematically illustrated in FIG. 11 are obtained.

In addition, the inference means 4 may determine the purchasing context groups, the product groups, and the store groups without determining the customer group. In this case, the inference means 4 may use a likelihood calculated by Expression (11) below.

$$\begin{matrix}[ Mathematical Expression 4 ] & \\ {\prod }_{s ∈ {S}_{s}}^{ } {\prod }_{x ∈ {S}_{x}} {\prod }_{i ∈ {S}_{i}}^{ } p ( {v}_{x , i} , {b}_{s , ⋆ , x} , {t}_{x} , {d}_{s} , {u}_{i} \vert θ , φ , γ , δ , η , {z}_{s}^{S} , {z}_{x}^{X} , {z}_{i}^{I} ) & Expression ( 11 )\end{matrix}$$

Expression (11) is a likelihood of a combination of the store groups to which each store ID belongs, the purchasing context groups to which each purchasing context ID belongs, the product groups to which each product ID belongs, and the distribution parameter sets θ, ϕ, γ, δ, η. In Expression (11), p(v_{x,i}, b_{s,*,x}, tₓ, dₛ, uᵢ|θ, ϕ, γ, δ, η, z^{S}ₛ, z^{X}ₓ, z^{I}ᵢ) is a probability that v_{x,i}, b_{s,*,x}, tₓ, dₛ, uᵢ occur under distribution parameters θ, ϕ, γ, δ, η.

The inference means 4 only needs to update z^{S}ₛ, z^{X}ₓ, z^{I}ᵢ, θ, ϕ, γ, δ, η so that the likelihood increases, and determine the purchasing context groups, the product groups, the store groups, and the distribution parameter sets θ, ϕ, γ, δ, η. As a result, the purchasing context ID groups, the product groups, and the store groups as schematically illustrated in FIG. 12 are obtained.

In addition, in Expression (8), Expression (9), Expression (10), and Expression (11), the elements tₓ and γ do not have to be included. In this case, the inference means 4 determines the various groups and the various parameters without considering tₓ and γ. However, the inference means 4 does not determine γ for each purchasing context group.

Similarly, in Expression (8), Expression (9), Expression (10), and Expression (11), the elements uᵢ and η do not have to be included. In this case, the inference means 4 determines the various groups and the various parameters without considering uᵢ and η. However, the inference means 4 does not determine η for each product group.

In addition, in Expression (8) and Expression (11), the elements dₛ and δ do not have to be included. In this case, the inference means 4 determines the various groups and various parameters without considering dₛ and δ. However, the inference means 4 does not determine δ for each store group.

In addition, in Expression (8) and Expression (10), the elements g_{c} and w do not have to be included. In this case, the inference means 4 determines the various groups and the various parameters without considering g_{c} and ψ. However, the inference means 4 does not determine ψ for each customer group.

Similarly, in Expression (8) and Expression (10), the elements a_{c} and α do not have to be included. In this case, the inference means 4 determines the various groups and various parameters without considering a_{c} and α. However, the inference means 4 does not determine α for each customer group.

In addition, the inference means 4 may determine the purchasing context group, allowing each purchasing context ID to belong to one or more purchasing context groups. Similarly, the inference means 4 may determine the product group, allowing each product ID to belong to one or more product groups. The inference means 4 may determine the customer group, allowing each customer ID to belong to one or more customer groups. The inference means 4 may determine the store group, allowing each store ID to belong to one or more store groups.

In addition, the inference means 4 may determine the various group by using Bregman divergence that is an asymptotic expansion of a probability model, instead of the probability model. Generally, the Bregman divergence exists in an exponential family. The inference means 4 may use the Bregman divergence to determine the various groups.

In addition, when the store is a department store, the inference means 4 may classify the departments instead of the products. Also in this case, the analyst can analyze the products likely to be simultaneously purchased and the department groups to which the products belong.

### Second Exemplary Embodiment

A grouping system of a second exemplary embodiment executes processing similar to the processing of the grouping system in the first exemplary embodiment, and further, on the basis of a processing result, determines a product to be recommended to a customer in accordance with a condition designated. The grouping system of the second exemplary embodiment can also be referred to as a recommended-product determination system.

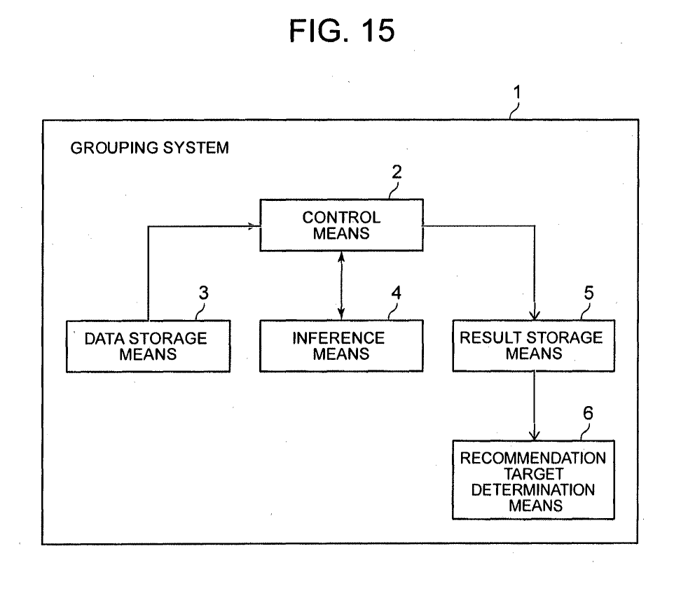

FIG. 15 depicts a block diagram illustrating a configuration example of the grouping system in the second exemplary embodiment of the present invention. A grouping system 1 of the present exemplary embodiment includes a control means 2, a data storage means 3, an inference means 4, a result storage means 5, and a recommendation target determination means 6. The control means 2, the data storage means 3, the inference means 4, and the result storage means 5 are respectively similar to the control means 2, the data storage means 3, the inference means 4, and the result storage means 5 in the first exemplary embodiment, so that the description thereof will be omitted.

Hereinafter, it is assumed that the inference means 4 uses a likelihood calculated by Expression (8) to determine purchasing context groups, product groups, customer groups, and store groups. Then, it is assumed that the control means 2 stores each of those groups in the result storage means 5. However, in an example shown below, the inference means 4 may determine the various groups and various parameters without considering uᵢ and η.

In addition, it is assumed that the result storage means 5 stores a distribution parameter of the number of products purchased (in other words, purchasing results), for each combination of the purchasing context group and the product group. Similarly, it is assumed that the result storage means 5 stores distribution of presence of a purchasing fact, for each combination of the store group, the customer group, and the purchasing context group. It is assumed that the result storage means 5 stores a distribution parameter of purchasing time, for each purchasing context group. It is assumed that the result storage means 5 stores a distribution parameter of a distance to a store from the nearest station of the store, for each store group. It is assumed that the result storage means 5 stores a distribution parameter of a gender and a distribution parameter of an age, for each customer group. These distribution parameters are obtained by the inference means 4.

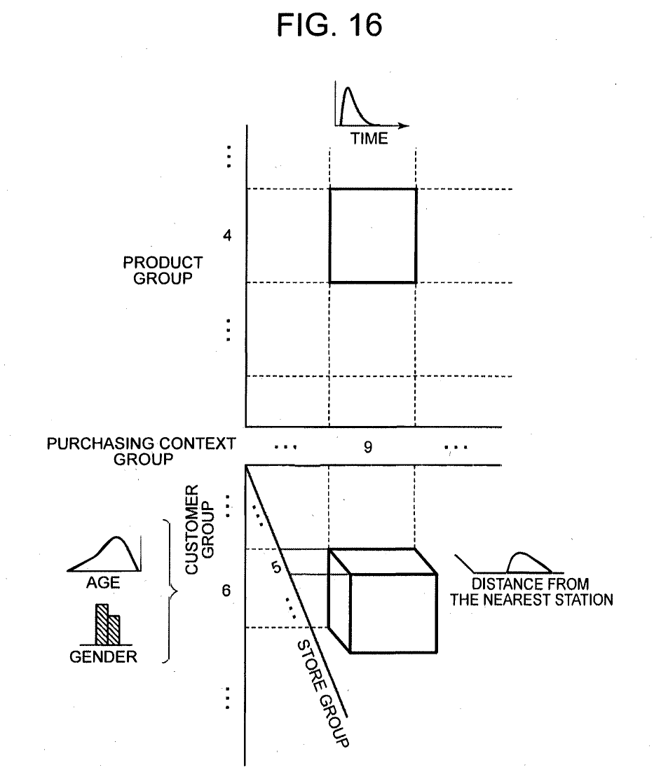

An example of distribution determined in accordance with the groups as described above is schematically illustrated in FIG. 16. Incidentally, in FIG. 16, an example is schematically illustrated of distribution of an attribute related to the purchasing context group “9”, the customer group “6”, and the store group “5”, and a distribution parameter of the attribute can be schematically illustrated for each group as exemplified in FIG. 16.

In addition, a portion including the result storage means 5 and the recommendation target determination means 6, and a portion including the control means 2, the data storage means 3, and the inference means 4 may be divided into different systems. In this case, the portion including the result storage means 5 and the recommendation target determination means 6 can be referred to as a recommended-product determination system.

It can be said that the result storage means 5 stores information indicating when a customer belonging to a customer group has simultaneously purchased products at a store, which store group the store belongs to, and which product group the products belong to.

To the recommendation target determination means 6, for example, a condition for specifying the product group is designated by an analyst. The recommendation target determination means 6, considering the various groups and the various distribution parameters stored in the result storage means 5, specifies a product group according to the condition designated, and determines a product in the group as the product to be recommended to the customer (hereinafter, referred to as a recommended product). The recommendation target determination means 6 may determine all the products belonging to the product group specified in accordance with the condition as the recommended product, and may determine some of the products belonging to the product group as the recommended product. Incidentally, the analyst only needs to input the condition into the recommendation target determination means 6 via an input device (not illustrated in FIG. 15) provided in the grouping system 1, for example.

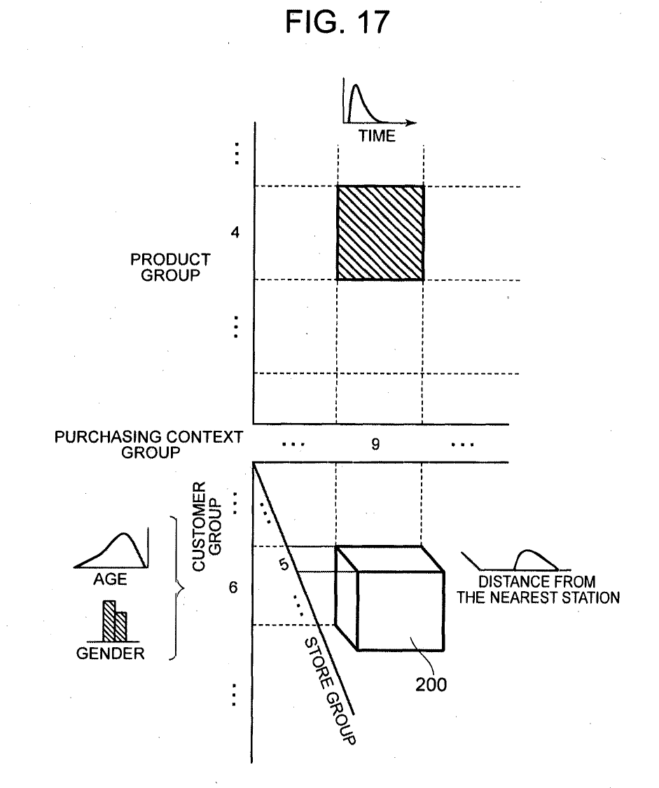

FIG. 17 depicts an explanatory diagram schematically illustrating an example of the product group determined by the recommendation target determination means 6. The recommendation target determination means 6 specifies a combination of the purchasing context group, the customer group, and the store group according to the condition designated (for example, specifies a region 200 illustrated in FIG. 17), and specifies a product group most likely to be purchased in the combination. In FIG. 17, a case is exemplified where the recommendation target determination means 6 specifies the product group “4”.

To the recommendation target determination means 6, as the condition, for example, some or all of the customer, the age of the customer, the gender of the customer, a place where the customer is, and time are designated.

Hereinafter, a case will be described where the age of the customer, the gender, the place where the customer is, and the time are designated, as an example.

In addition, an ID of the purchasing context group is represented by a variable z^{X}. Similarly, an ID of the product group is represented by a variable z^{I}. An ID of the customer group is represented by a variable z^{C}. An ID of the store group is represented by a variable z^{S}. At this time, the recommendation target determination means 6 specifies a product group according to the age, the gender, the place where the customer is, and the time designated, by an arithmetic operation of Expression (12) shown below. In the left side of Expression (12), k^{I*} means a most suitable product group including the recommended product.

$$\begin{matrix}[ Mathematical Expression 5 ] & \\ {k}^{I ⋆} = {argmax}_{k}^{I} {\int }_{1}^{∞} {\sum }_{{k}^{X}} {\sum }_{{k}^{S}}^{ } {\sum }_{{k}^{C}}^{ } p ( d \vert δ , {z}^{S} = {k}^{S} ) p ( t \vert γ , {z}^{X} = {k}^{X} ) p ( 1 \vert φ , {z}^{S} = {k}^{S} , {z}^{C} = {k}^{C} , {z}^{X} = {k}^{X} ) p ( a \vert α , {z}^{C} = {k}^{C} ) p ( g \vert ψ , {z}^{C} = {k}^{C} ) p ( v \vert θ , {z}^{I} = {k}^{I} , {z}^{X} = {k}^{X} ) dv & Expression ( 12 )\end{matrix}$$

Here, the designated age is a. The designated gender is g. The designated time is t. Incidentally, the recommendation target determination means 6 may include, for example, map information, and use an attribute of the store within a predetermined range from the place where the customer is (the distance to the store from the nearest station of the store) as d.

The recommendation target determination means 6 specifies the product group k^{I*} by the arithmetic operation of Expression (12), and then determines a product belonging to the product group as the recommended product.

In addition, a customer ID may be designated as the condition. In this case, the recommendation target determination means 6 only needs to fixedly determine a possible value of the variable z^{C} in Expression (12) (the ID of the customer group) only for the ID of the customer group to which the customer ID designated belongs. In addition, when the customer ID is designated as the condition, even when the age and the gender of the customer specified by the customer ID are not designated, the recommendation target determination means 6 may refer to a customer master stored in the data storage means 3 and regard that the age and the gender corresponding to the customer ID are designated.

In addition, when the customer ID is designated as the condition, the recommendation target determination means 6 may specify a product having been purchased by the customer specified by the customer ID, by referring to the purchasing context associated with the customer ID. Then, the recommendation target determination means 6 may specify the product group V, and then determine a product that is a product belonging to the product group and has been purchased by the customer, as the recommended product. Alternatively, the recommendation target determination means 6 may determine a product that is a product belonging to the product group and has not been purchased by the customer, as the recommended product.

In addition, the age does not have to be included in the condition designated by the analyst. In this case, the recommendation target determination means 6, during the arithmetic operation of Expression (12), may specify the product group V by excluding the element “p(a|α, z^{C}=k^{C})” in Expression (12) and performing the arithmetic operation. In addition, In this case, the inference means 4 may determine the various groups and the various parameters without considering a_{c} and α.

In addition, the gender does not have to be included in the condition designated by the analyst. In this case, the recommendation target determination means 6, during the arithmetic operation of Expression (12), may specify the product group k^{I*} by excluding the element “p(g|ψ, z^{C}=k^{C})” in Expression (12) and performing the arithmetic operation. In addition, in this case, the inference means 4 may determine the various groups and the various parameters without considering g_{c} and ψ.

In addition, the place where the customer is does not have to be included in the condition designated by the analyst. In this case, the recommendation target determination means 6, during the arithmetic operation of Expression (12), may specify the product group k^{I*} by excluding the element “p(d|δ, z^{S}=k^{S})” in Expression (12) and performing the arithmetic operation. In addition, in this case, the inference means 4 may determine the various groups and the various parameters without considering dₛ and δ.

In addition, the time does not have to be included in the condition designated by the analyst. In this case, the recommendation target determination means 6, during the arithmetic operation of Expression (12), may specify the product group k^{I*} by excluding the element “p(t|γ, z^{X}=k^{X})” in Expression (12) and performing the arithmetic operation. In this case, the inference means 4 may determine the various groups and the various parameters without considering tₓ and γ.

Hereinafter, a case will be exemplified where the customer (customer ID), the place where the customer is, and the time are designated as the condition. In this case, the result storage means 5 does not have to store the distribution parameter of the gender for each customer group, or the distribution parameter of the age for each customer group.

In this case, the recommendation target determination means 6 only needs to specify a most suitable product group k^{I*} by an arithmetic operation of Expression (13) shown below, for example.

$$\begin{matrix}[ Mathematical Expression 6 ] & \\ {k}^{I ⋆} = {argmax}_{k}^{I} {\int }_{1}^{∞} {\sum }_{{k}^{X}} {\sum }_{{k}^{S}}^{ } {\sum }_{{k}^{C}}^{ } p ( d \vert δ , {z}^{S} = {k}^{S} ) p ( t \vert γ , {z}^{X} = {k}^{X} ) p ( 1 \vert φ , {z}^{S} = {k}^{S} , {z}^{C} = {k}^{C} , {z}^{X} = {k}^{X} ) p ( v \vert θ , {z}^{I} = {k}^{I} , {z}^{X} = {k}^{X} ) dv & Expression ( 13 )\end{matrix}$$

As described above, the recommendation target determination means 6 may include, for example, the map information, and use the attribute of the store within the predetermined range from the place where the customer is (the distance to the store from the nearest station of the store) as d. In addition, the possible value of the variable z^{C} (the ID of the customer group) only needs to be fixedly determined only for the ID of the customer group to which the customer ID designated belongs.

Then, the recommendation target determination means 6 only needs to determine a product in the product group k^{I*} as the recommended product.

The control means 2, the inference means 4, and the recommendation target determination means 6 are realized by a CPU of a computer, for example. In this case, the CPU only needs to read a grouping program from a program recording medium such as a program storage device of the computer (not illustrated in FIG. 15), and operate as the control means 2, the inference means 4, and the recommendation target determination means 6 in accordance with the grouping program. Incidentally, the program can also be referred to as a recommended-product determination program.

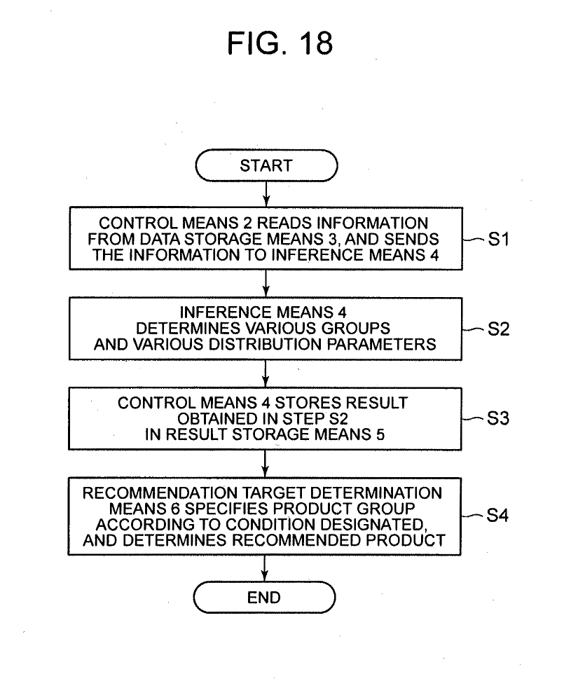

FIG. 18 depicts a flowchart illustrating an example of processing progress of the second exemplary embodiment. Steps S1 to S3 are similar to steps S1 to S3 in the first exemplary embodiment, so that the description thereof will be omitted. After step S3, the recommendation target determination means 6 specifies a product group according to the condition designated, and determines the recommended product (step S4). Since operation of the recommendation target determination means 6 has already been described, the description thereof will be omitted here.

According to the present exemplary embodiment, the recommendation target determination means 6 refers to the information stored in the result storage means 5 to specify a product group according to the condition designated, and determines a product belonging to the product group as the recommended product. Therefore, such a recommended product can be known to the customer, and as a result, a product sales volume can be increased.

In addition, a similar effect to the first exemplary embodiment is also obtained.

In addition, in the above description, the case has been described where the recommendation target determination means 6 performs the arithmetic operation for specifying the most suitable product group k^{I*} in accordance with the condition designated. The recommendation target determination means 6 may specify the most suitable product group k^{I*} according to the condition, for each of the various conditions in advance, and create a rule indicating which product group becomes the most suitable product group when what kind of condition is designated, and store the rule in a database. Then, the recommendation target determination means 6, when the condition is designated by the analyst, may specify the most suitable product group in accordance with the rule. In this case, the recommendation target determination means 6 can reduce an amount of the arithmetic operation of when the condition is designated by the analyst, so that response time to the analyst can be reduced.

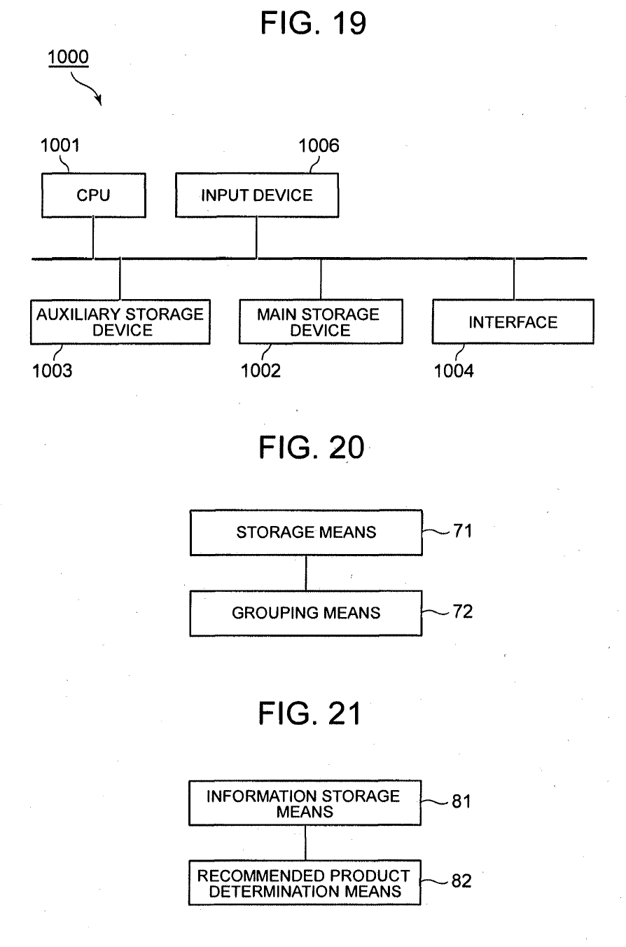

FIG. 19 depicts a schematic block diagram illustrating a configuration example of a computer according to each exemplary embodiment of the present invention. A computer 1000 includes a CPU 1001, a main storage device 1002, an auxiliary storage device 1003, an interface 1004, and an input device 1006.

The grouping system of each exemplary embodiment is implemented in the computer 1000. Operation of the grouping system is stored in the auxiliary storage device 1003 in a format of a program. The CPU 1001 reads the program from the auxiliary storage device 1003, and deploys the program on the main storage device 1002, and then executes the processing described above in accordance with the program.

The auxiliary storage device 1003 is an example of a non-transitory tangible medium. Other examples of the non-transitory tangible medium include a semiconductor memory, DVD-ROM, CD-ROM, a magneto-optical disk, and a magnetic disk connected via the interface 1004. In addition, when the program is delivered to the computer 1000 through a communication line, the computer 1000 receiving the delivery may deploy the program on the main storage device 1002 and execute the processing described above.

In addition, the program may be the one for partially realizing the above-described processing. Further, the program may be a differential program that realizes the above-described processing in combination with another program already stored in the auxiliary storage device 1003.

Next, an outline of the present invention will be described. FIG. 20 depicts a block diagram illustrating an outline of a grouping system of the present invention. A grouping system of the present invention includes a storage means 71, and a grouping means 72.

The storage means 71 (for example, the data storage means 3) stores at least a purchasing context that is information indicating one or more types of products purchased in one purchasing activity.

The grouping means 72 (for example, the inference means 4) uses a likelihood of a combination of a group of purchasing contexts, a group of products, and a distribution parameter of a purchasing result, calculated by using the purchasing result corresponding to a combination of the group of the purchasing contexts and the group of the products, and the distribution parameter of the purchasing result, to determine the group of the purchasing contexts, the group of the products, and the distribution parameter of the purchasing result.

In addition, FIG. 21 depicts a block diagram illustrating an outline of a recommended-product determination system of the present invention. A recommended-product determination system of the present invention includes an information storage means 81, and a recommended-product determination means 82.

The information storage means 81 (for example, the result storage means 5) stores information indicating when a customer belonging to a customer group has simultaneously purchased products at a store, which store group the store belongs to, and which product group the products belong to.

The recommended-product determination means 82 (for example, the recommendation target determination means 6), when the customer, time and a place where the customer is are designated, uses the information and determines a most suitable product group including a recommended product for the customer, and determines a product in the product group as the recommended product.

Each exemplary embodiment described above can also be described as the following supplementary notes but are not limited thereto.

(Supplementary note 1) A grouping system including: a storage means that stores at least a purchasing context that is information indicating one or more types of products purchased in one purchasing activity; and a grouping means that uses a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

(Supplementary note 2) The grouping system according to supplementary note 1, wherein the storage means stores information associating a purchasing context and a customer with each other, and the grouping means uses a likelihood of a combination of a group of the purchasing contexts, a group of the products, a group of the customers, a distribution parameter of a purchasing result, and a distribution parameter of presence of a purchasing fact, calculated by using the purchasing result corresponding to the combination of the group of the purchasing contexts and the group of the products, and the distribution parameter of the purchasing result, and the presence of the purchasing fact corresponding to the combination of the group of the purchasing contexts and the group of the customers, and the distribution parameter of the presence of the purchasing fact, to determine the group of the purchasing contexts, the group of the products, the group of the customers, the distribution parameter of the purchasing result, and the distribution parameter of the presence of the purchasing fact.

(Supplementary note 3) The grouping system according to supplementary note 1, wherein the storage means stores information associating a purchasing context and a store with each other, and the grouping means uses a likelihood of a combination of a group of the purchasing contexts, a group of the products, a group of the stores, a distribution parameter of a purchasing result, and a distribution parameter of presence of a purchasing fact, calculated by using the purchasing result corresponding to the combination of the group of the purchasing contexts and the group of the products, and the distribution parameter of the purchasing result, and the presence of the purchasing fact corresponding to the combination of the group of the purchasing contexts and the group of the stores, and the distribution parameter of the presence of the purchasing fact, to determine the group of the purchasing contexts, the group of the products, the group of the stores, the distribution parameter of the purchasing result, and the distribution parameter of the presence of the purchasing fact.

(Supplementary note 4) The grouping system according to supplementary note 1, wherein the storage means stores information associating a purchasing context, a customer, and a store with each other, and the grouping means uses a likelihood of a combination of a group of the purchasing contexts, a group of the products, a group of the customers, a group of the stores, a distribution parameter of a purchasing result, and a distribution parameter of presence of a purchasing fact, calculated by using the purchasing result corresponding to the combination of the group of the purchasing contexts and the group of the products, and the distribution parameter of the purchasing result, and the presence of the purchasing fact corresponding to the combination of the group of the purchasing contexts, the group of the customers, and the group of the stores, and the distribution parameter of the presence of the purchasing fact, to determine the group of the purchasing contexts, the group of the products, the group of the customers, the group of the stores, the distribution parameter of the purchasing result, the distribution parameter of the presence of the purchasing fact.

(Supplementary note 5) The grouping system according to supplementary note 2 or 4, wherein the storage means stores information associating a customer and an age of the customer with each other, and the grouping means uses a likelihood calculated by using the age and a distribution parameter of the age.

(Supplementary note 6) The grouping system according to any of supplementary notes 2, 4, and 5, wherein the storage means stores information associating a customer and a gender of the customer with each other, and the grouping means uses a likelihood calculated by using the gender and a distribution parameter of the gender.

(Supplementary note 7) The grouping system according to supplementary note 3 or 4, wherein the storage means stores information associating a store and a distance to the store from the nearest station of the store with each other, and the grouping means uses a likelihood calculated by using the distance and a distribution parameter of the distance.

(Supplementary note 8) The grouping system according to any of supplementary notes 1 to 7, wherein the storage means stores information associating a product and a product classification determined for the product with each other, and the grouping means uses a likelihood calculated by using the product classification and a distribution parameter of the product classification.

(Supplementary note 9) The grouping system according to any of supplementary notes 1 to 8, wherein the storage means stores information associating a purchasing context and purchasing time with each other, and the grouping means uses a likelihood calculated by using the purchasing time and a distribution parameter of the purchasing time.

(Supplementary note 10) The grouping system according to supplementary note 4, wherein the storage means stores information associating a customer, and an age and a gender of the customer with each other, information associating a store and a distance to the store from the nearest station of the store with each other, and information associating a purchasing context and purchasing time with each other, and the grouping means uses a likelihood calculated by using the age, a distribution parameter of the age, the gender, a distribution parameter of the gender, the distance, a distribution parameter of the distance, the purchasing time, and a distribution parameter of the purchasing time, the grouping system comprising, a recommended-product determination means that, when some or all conditions of the customer, the age of the customer, the gender of the customer, a place where the customer is, and time are designated, determines a most suitable product group including a recommended product for the customer in accordance with the conditions, and determines a product in the product group as the recommended product.

(Supplementary note 11) A recommended-product determination system including: an information storage means that stores information indicating when a customer belonging to a customer group has simultaneously purchased products at a store, which store group the store belongs to, and which product group the products belong to, and a recommended-product determination means that, when a customer, time and a place where the customer is are designated, uses the information, to determine a most suitable product group including a recommended product for the customer, and determine a product in the product group as the recommended product.

(Supplementary note 12) A grouping method to be applied to a grouping system including a storage means that stores at least a purchasing context that is information indicating one or more types of products purchased in one purchasing activity, the grouping method including using a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

(Supplementary note 13) A recommended-product determination method including: deriving information indicating when a customer belonging to a customer group has simultaneously purchased products at a store, which store group the store belongs to, and which product group the products belong to; and, when a customer, time, and a place where the customer is are designated, using the information, to determine a most suitable product group including a recommended product for the customer, and determine a product in the product group as the recommended product.

(Supplementary note 14) A grouping program to be mounted on a computer including a storage means that stores at least a purchasing context that is information indicating one or more types of products purchased in one purchasing activity, the grouping program causing the computer to execute grouping processing that uses a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

(Supplementary note 15) A recommended-product determination program to be mounted on a computer including an information storage means that stores information indicating when a customer belonging to a customer group has simultaneously purchased products at a store, which store group the store belongs to, and which product group the products belong to, the recommended-product determination program causing the computer to execute recommended-product determination processing that, when a customer, time, and a place where the customer is are designated, uses the information, to determine a most suitable product group including a recommended product for the customer, and determine a product in the product group as the recommended product.

In the above, the present invention has been described with reference to the exemplary embodiments; however, the present invention is not limited to the exemplary embodiments described above. Various modifications that can be understood by those skilled in the art within the scope of the present invention can be made to the configuration and details of the present invention.

This application claims priority based on Japanese Patent Application No. 2015-035238 filed on Feb. 25, 2015, the disclosure of which is incorporated herein in its entirety.

### INDUSTRIAL APPLICABILITY

The present invention is suitably applied to a grouping system that groups a purchasing context and a product together, and a recommended-product determination system that determines a recommended product.

### REFERENCE SIGNS LIST

1 Grouping system
2 Control means
3 Data storage means
4 Inference means
5 Result storage means
6 Recommendation target determination means

1. A grouping system comprising:
a storage unit, implemented by a storage device, that stores at least a purchasing context that is information indicating one or more types of products purchased in one purchasing activity; and
a grouping unit, implemented by a processor, that uses a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

2. The grouping system according to claim 1, wherein
the storage unit stores information associating a purchasing context and a customer with each other, and
the grouping unit uses a likelihood of a combination of a group of the purchasing contexts, a group of the products, a group of the customers, a distribution parameter of a purchasing result, and a distribution parameter of presence of a purchasing fact, calculated by using the purchasing result corresponding to the combination of the group of the purchasing contexts and the group of the products, and the distribution parameter of the purchasing result, and the presence of the purchasing fact corresponding to the combination of the group of the purchasing contexts and the group of the customers, and the distribution parameter of the presence of the purchasing fact, to determine the group of the purchasing contexts, the group of the products, the group of the customers, the distribution parameter of the purchasing result, and the distribution parameter of the presence of the purchasing fact.

3. The grouping system according to claim 1, wherein
the storage unit stores information associating a purchasing context and a store with each other, and
the grouping unit uses a likelihood of a combination of a group of the purchasing contexts, a group of the products, a group of the stores, a distribution parameter of a purchasing result, and a distribution parameter of presence of a purchasing fact, calculated by using the purchasing result corresponding to the combination of the group of the purchasing contexts and the group of the products, and the distribution parameter of the purchasing result, and the presence of the purchasing fact corresponding to the combination of the group of the purchasing contexts and the group of the stores, and the distribution parameter of the presence of the purchasing fact, to determine the group of the purchasing contexts, the group of the products, the group of the stores, the distribution parameter of the purchasing result, and the distribution parameter of the presence of the purchasing fact.

4. The grouping system according to claim 1, wherein
the storage unit stores information associating a purchasing context, a customer, and a store with each other, and
the grouping unit uses a likelihood of a combination of a group of the purchasing contexts, a group of the products, a group of the customers, a group of the stores, a distribution parameter of a purchasing result, and a distribution parameter of presence of a purchasing fact, calculated by using the purchasing result corresponding to the combination of the group of the purchasing contexts and the group of the products, and the distribution parameter of the purchasing result, and the presence of the purchasing fact corresponding to the combination of the group of the purchasing contexts, the group of the customers, and the group of the stores, and the distribution parameter of the presence of the purchasing fact, to determine the group of the purchasing contexts, the group of the products, the group of the customers, the group of the stores, the distribution parameter of the purchasing result, the distribution parameter of the presence of the purchasing fact.

5. The grouping system according to claim 2, wherein
the storage unit stores information associating a customer and an age of the customer with each other, and
the grouping unit uses a likelihood calculated by using the age and a distribution parameter of the age.

6. The grouping system according to claim 2, wherein
the storage unit stores information associating a customer and a gender of the customer with each other, and
the grouping unit uses a likelihood calculated by using the gender and a distribution parameter of the gender.

7. The grouping system according to claim 3, wherein
the storage unit stores information associating a store and a distance to the store from the nearest station of the store with each other, and
the grouping unit uses a likelihood calculated by using the distance and a distribution parameter of the distance.

8. The grouping system according to claim 1, wherein
the storage mcans unit stores information associating a product and a product classification determined for the product with each other, and
the grouping unit uses a likelihood calculated by using the product classification and a distribution parameter of the product classification.

9. The grouping system according to claim 1, wherein
the storage unit stores information associating a purchasing context and purchasing time with each other, and
the grouping unit uses a likelihood calculated by using the purchasing time and a distribution parameter of the purchasing time.

10. The grouping system according to claim 4, wherein
the storage unit stores information associating a customer, and an age and a gender of the customer with each other, information associating a store and a distance to the store from the nearest station of the store with each other, and information associating a purchasing context and purchasing time with each other, and
the grouping unit uses a likelihood calculated by using the age, a distribution parameter of the age, the gender, a distribution parameter of the gender, the distance, a distribution parameter of the distance, the purchasing time, and a distribution parameter of the purchasing time,
the grouping system comprising,
a recommended-product determination unit, implemented by the processor, that, when some or all conditions of the customer, the age of the customer, the gender of the customer, a place where the customer is, and time are designated, determines a most suitable product group including a recommended product for the customer in accordance with the conditions, and determines a product in the product group as the recommended product.

11. A recommended-product determination system comprising:
an information storage unit, implemented by a storage device, that stores information indicating when a customer belonging to a customer group has simultaneously purchased products at a store, which store group the store belongs to, and which product group the products belong to; and
a recommended-product determination unit, implemented by a processor, that, when a customer, time and a place where the customer is are designated, uses the information, to determine a most suitable product group including a recommended product for the customer, and determine a product in the product group as the recommended product.

12. A grouping method to be applied to a grouping system including a storage unit that stores at least a purchasing context that is information indicating one or more types of products purchased in one purchasing activity,
the grouping method comprising using a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

13. A recommended-product determination method comprising:
deriving information indicating when a customer belonging to a customer group has simultaneously purchased products at a store, which store group the store belongs to, and which product group the products belong to; and,
when a customer, time, and a place where the customer is are designated, using the information, to determine a most suitable product group including a recommended product for the customer, and determine a product in the product group as the recommended product.

14. A non-transitory computer-readable recording medium in which a grouping program is recorded, the grouping program to be mounted on a computer including a storage unit that stores at least a purchasing context that is information indicating one or more types of products purchased in one purchasing activity,
the grouping program causing the computer to execute grouping processing that uses a likelihood of a combination of a group of the purchasing contexts, a group of the products, and a distribution parameter of a purchasing result, calculated by using the purchasing result corresponding to the combination of the group of the purchasing contexts and the group of the products, and the distribution parameter of the purchasing result, to determine the group of the purchasing contexts, the group of the products, and the distribution parameter of the purchasing result.

15. A non-transitory computer-readable recording medium in which a recommended-product determination program is recorded, the recommended-product determination program to be mounted on a computer including an information storage unit that stores information indicating when a customer belonging to a customer group has simultaneously purchased products at a store, which store group the store belongs to, and which product group the products belong to,
the recommended-product determination program causing the computer to execute recommended-product determination processing that, when a customer, time, and a place where the customer is are designated, uses the information, to determine a most suitable product group including a recommended product for the customer, and determine a product in the product group as the recommended product.
